(19) United States
(12) Patent Application Publication
(10) Pub. No.: US 2003/0010954 A1
(43) Pub. Date: Jan. 16, 2003

(54) Structure of a valve

(76) Inventor: Ming Tien Wu, Taipei City (TW)

Correspondence Address: Ming Tien WU, PO Box 82-144, Taipei, TW

(21) Appl. No.: 09/904,534

(22) Filed: Jul. 16, 2001

(51) Int. Cl. F16K 27/10

(52) U.S. Cl. 251/366

(57) ABSTRACT

A valve body includes a connecting ring at a top thereof, a first sectorial tube at a bottom thereof, a first connecting tube connected with the sectorial tube, a second sectorial tube connected with one side of the valve body, and a second connecting tube connected with the second sectorial tube, wherein the connecting ring, the first sectorial tube, the first connecting tube, the second sectorial tube and the second connecting tube are integrally formed with the valve body so that number of component parts can be largely reduced and manufacturing process is simplified and furthermore, no welding operation is required and the valve body will not leak or deform subject to heat evolved during welding operation, and moreover, as the number of the component parts are reduced, management becomes easier, thereby facilitating the manufacturing process and lowering the cost.

### BACKGROUND OF THE INVENTION

The conventional valve body is generally composed of a number of portions which required at least three times of welding operation to form a whole valve body. Hence, the conventional valve body is high in cost and often has leakage and is easily deformed. Furthermore, the branch pipe cannot be accurately connected with the valve body by welding so that when the valve body is to be connected with other pipes, it is often necessary to modify the valve body in order to engage with the other pipes thereby causing much inconvenience in use. Moreover, a large number of component parts must be constantly available in stock thereby making it difficult to manage.

Therefore, it is an object of the present invention to provide an improvement in the structure of a valve body which can obviate and mitigate the above-mentioned drawbacks.

### SUMMARY OF THE INVENTION

This invention is related to an improvement in the structure of a valve body.

It is the primary object of the present invention to provide an improvement in the structure of a valve body which does not require welding operation in manufacture.

It is another object of the present invention to provide an improvement in the structure of a valve body which will not leak or deform thereby improving the quality.

It is a further object of the present invention to provide an improvement in the structure of a valve body which can reduce the number of component parts, making management easier, simplifying the manufacturing process and lowering the cost.

According to a preferred embodiment of the present invention, a valve body includes a connecting ring at a top thereof, a first sectorial tube at a bottom thereof, a first connecting tube connected with the sectorial tube, a second sectorial tube connected with one side of the valve body, and a second connecting tube connected with the second sectorial tube, wherein the connecting ring, the first sectorial tube, the first connecting tube, the second sectorial tube and the second connecting tube are integrally formed with the valve body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is a perspective view of a second preferred embodiment according to the present invention;

FIG. 3 is a sectional view of the second preferred embodiment;

FIG. 4 is a working view of the present invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

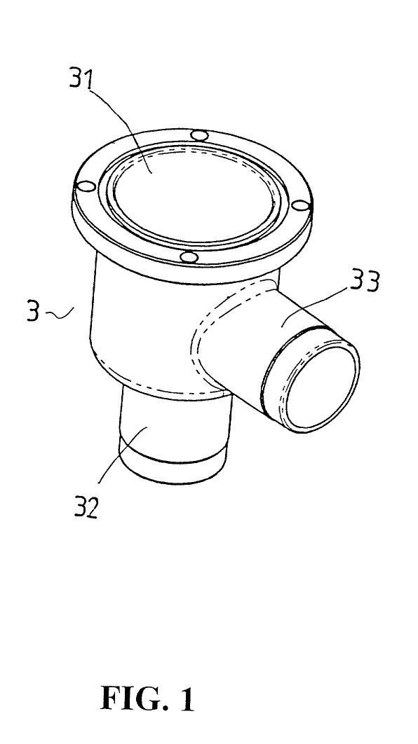

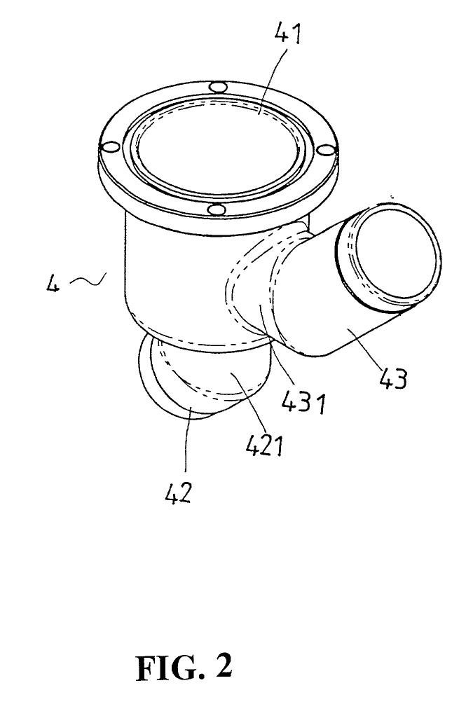

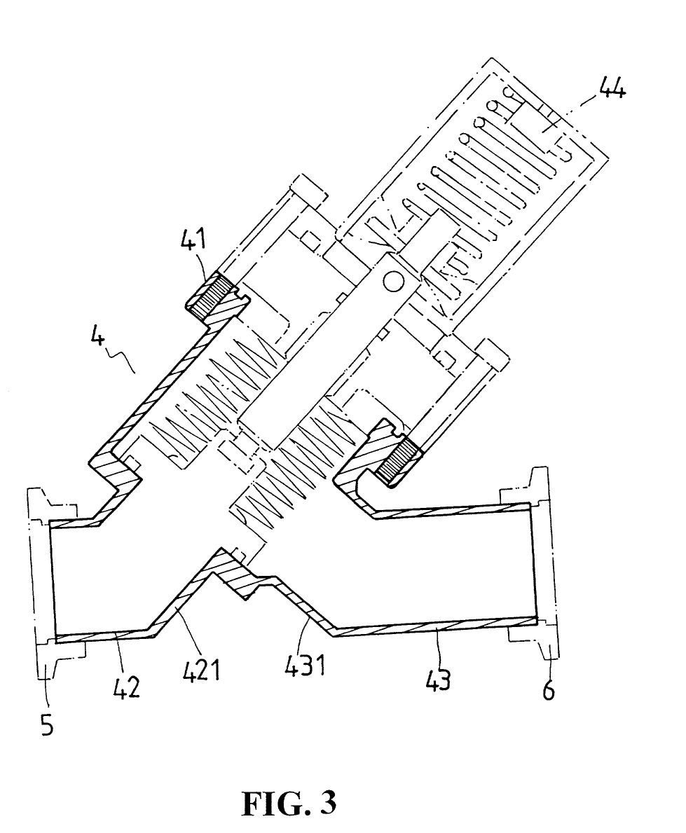

With reference to the drawings and in particular to FIG. 1 thereof, the valve body 3 according to the present invention comprises a connecting ring 31 at the top, a connecting tube 32 at the bottom, and a branch tube 33 at one side. The connecting ring 31, the connecting tube 32 and the branch tube 33 are formed integrally with the valve body 3 so that the number of the component parts can be largely reduced thereby simplifying the manufacturing process. Furthermore, the present invention does not require welding operation at all and so the valve body 3 will not leak or deform subject to the heat evolved during welding operation. In addition, as the number of component parts are reduced, the management becomes easier thus simplifying the manufacturing process and lowering the cost. FIGS. 2 and 3 illustrate a second preferred embodiment of the present invention. As shown, the valve body 4 is provided with a connecting ring 41 at the top, a first sectorial tube 421 at the bottom, a first connecting tube 42 connected with the sectorial tube 421, a second sectorial tube 431 connected with one side of the valve body 4, and a second connecting tube 43 connected with the second sectorial tube 431. As shown, a switch 44 is fitted within the valve body 4. The connecting ring 41, the first sectorial tube 421, the first connecting tube 42, the second sectorial tube 431 and the second connecting tube 43 are integrally formed with the valve body 4 so that the number of the component parts can be largely reduced and the manufacturing process is simplified. Furthermore, the present invention does not require welding operation at all and so the valve body 4 will not leak or deform subject to the heat evolved during welding operation and moreover, as the number of component parts are reduced, the management becomes easier, thereby facilitating the manufacturing process and lowering the cost.

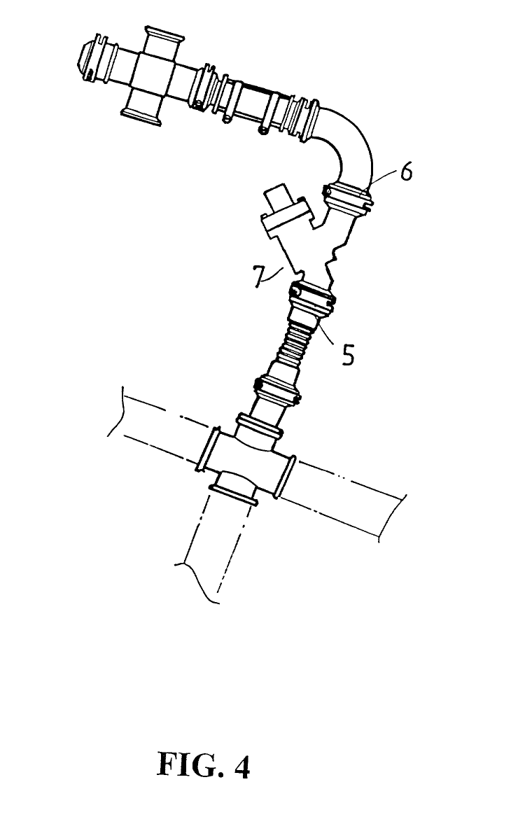

FIG. 4 is a working view of the present invention. As illustrated, the valve body 4 according to the present invention can be easily connected with pipes 5 and 6. As the valve body 4 is integrally formed, it can be accurately manufactured and so the valve body 4 can be easily connected with the pipes 5 and 6 without any modifications thereby saving time and money in the operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A valve body comprising a connecting ring at a top thereof, a first sectorial tube at a bottom thereof, a first connecting tube connected with said sectorial tube, a second sectorial tube connected with one side of said valve body, and a second connecting tube connected with said second sectorial tube, wherein said connecting ring, said first sectorial tube, said first connecting tube, said second sectorial tube and said second connecting tube are integrally formed with said valve body so that number of component parts can be largely reduced and manufacturing process is simplified and furthermore, no welding operation is required and said valve body will not leak or deform subject to heat evolved during welding operation, and moreover, as the number of the component parts are reduced, management becomes easier, thereby facilitating the manufacturing process and lowering the cost.
